(19) United States
(12) Patent Application Publication
(10) Pub. No.: US 2009/0157982 A1
(43) Pub. Date: Jun. 18, 2009

(54) MULTIPLE MISS CACHE

(76) Inventors: Alexander G. MacInnis, Ann Arbor, MI (US); Lei Zhang, San Jose, CA (US)

Correspondence Address: MCANDREWS HELD & MALLOY, LTD, 500 WEST MADISON STREET, SUITE 3400, CHICAGO, IL, 60661, US

(21) Appl. No.: 12/334,710

(22) Filed: Dec. 15, 2008

Related U.S. Application Data
(60) Provisional application No. 61/014,503, filed on Dec. 18, 2007.

(51) Int. Cl. G06F 12/08

(52) U.S. Cl. 711/145; 711/E12.033

(57) ABSTRACT

Presented herein are system(s) and method(s) for a multiple miss cache. In one embodiment, there is presented a cache system for storing data. The cache comprises a plurality of data words, a plurality of first bits, and a plurality of second bits. The plurality of data words store data. The plurality of first bits correspond to particular ones of the plurality of data words, each of the plurality of bits indicating whether the data word corresponding thereto stores valid data. The plurality of second bits correspond to particular ones of the plurality of data words, each of the plurality of bits for indicating whether a cache miss has occurred with the data word corresponding thereto.

### RELATED APPLICATIONS

This application claims the benefit of and priority to “Multiple Miss Cache”, U.S. Provisional Application Ser. No. 61/014,503, filed Dec. 18, 2007 by MacInnis et. al, which is incorporated by reference in its entirety. This application is related to “Video Cache”, U.S. patent application Ser. No. 10/850,911, filed May 21, 2004 by MacInnis which is incorporated by reference in its entirety.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Certain applications can require a large number of memory accesses in real-time operation. The ability to support large numbers of memory accesses in real time can result in an expensive memory system.

Limitations and disadvantages of conventional and traditional approaches will become apparent to one of ordinary skill in the art through comparison of such systems with the present invention as set forth in the remainder of the present application with reference to the drawings.

### BRIEF SUMMARY OF THE INVENTION

The present invention is directed to a multiple miss cache as shown in and/or described in connection with at least one of the figures, as set forth more completely in the claims.

These and other features and advantages of the present invention may be appreciated from a review of the following detailed description of the present invention, along with the accompanying figures in which like reference numerals refer to like parts throughout.

### BRIEF DESCRIPTION OF SEVERAL VIEWS OF THE DRAWINGS

FIG. 1 is a block diagram of exemplary data words in accordance with an embodiment of the present invention;

FIG. 2 is a flow diagram for providing data in accordance with an embodiment of the present invention;

FIG. 3 is a block diagram of an exemplary cache in accordance with an embodiment of the present invention;

FIG. 4 is a flow diagram for providing data in accordance with an embodiment of the present invention;

FIG. 5 is a block diagram of an exemplary encoder in accordance with an embodiment of the present invention; and

FIG. 6 is a block diagram of an exemplary video decoder in accordance with an embodiment of the present invention.

### DETAILED DESCRIPTION OF THE INVENTION

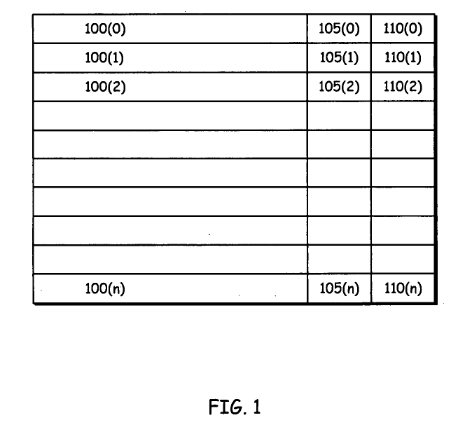

Referring now to FIG. 1, there is illustrated a block diagram describing exemplary memory data words 100(0 . . . n) in accordance with an embodiment of the present invention. The data words 100(0 . . . n) are associated with a plurality of first bits 105(0 . . . n), and a plurality of second bits 110(0 . . . n).

The plurality of first bits 105(0 . . . n) correspond to the plurality of data words 100(0 . . . n). Each of the plurality of first bits 105 corresponding to a data word 100 indicates whether the data word 100 corresponding thereto stores valid data or not.

The plurality of second bits 110(0 . . . n) correspond to the plurality of data words 100(0 . . . n). Each of the second plurality of bits 110 indicates whether the data word 100 associated with it was previously requested access and found to have invalid data.

The foregoing data words can be used for a variety of applications. For example, the data words 100 can be used for a cache system. In an exemplary cache system, the data words 100 can form a portion of a cache memory. The cache memory that includes the data words 100 can be mapped to another memory. The cache memory that includes the data words is generally faster than the other memory, while the other memory generally has more data capacity than the cache memory.

When a data word 100 in the cache memory is mapped to a data word in the other memory, it may not immediately store the contents of the data word in the other memory. Accordingly, each of the plurality of first bits 105(0 . . . n) can be initialized to indicate that the data word 100(0 . . . n) corresponding thereto does not store valid data.

When an attempt is made to access a particular data word 100, the first bit 105 corresponding to the data word 100 can be examined. If the first bit indicates that the data word 100 does not store valid data, the contents of the data word in the other memory that is mapped to the data word 100 are fetched and stored in the data word 100 and returned to the requesting client.

It is noted that fetching the data from the other memory can take considerable time. While the data is being fetched from the other memory, additional requests may be made to the same data word 100. Additional fetches to the data word in the other memory that is mapped to the data word 100 are redundant and waste processing cycles.

Additional redundant fetches to the data word in the other memory can be prevented by use of the plurality of second bits 110. Each of the plurality of second bits 110(0 . . . n) indicate whether a previous request to the corresponding data word 100(0 . . . n) was made, wherein the corresponding data word 100(0 . . . n) stored invalid data. The second bits 110 (0 . . . n) may be referred to as “already missed” bits.

When a request is made to a data word 100 storing invalid data, as indicated by the corresponding one of the plurality of first bits 105, the corresponding one of the second bits 110 can be examined. A fetch to the data word in the other memory that is mapped to the data word 100 is made on the condition that the corresponding one of the second bits 110 does not indicate that a previous request to the corresponding data word 100(0 . . . n) was made, wherein the corresponding data word 100(0 . . . n) stored invalid data.

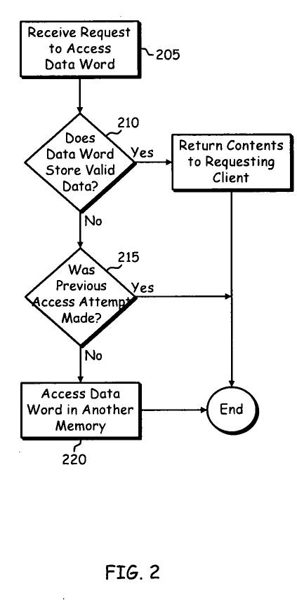

Referring now to FIG. 2, there is illustrated a flow diagram for fetching data in accordance with an embodiment of the present invention. At 205, a request to access a data word in another memory that is mapped to a particular data word 100 in the cache memory is received.

At 210, a determination is made whether the data word 100 stores valid data. In certain embodiments of the present invention, this determination can be made by examining a first bit 105 corresponding to the data word 100. If the data word 100 stores valid data, the contents of data word 100 are returned to the requesting client at 115.

If at 210, the data word 100 does not store valid data, a determination is made at 215 whether a previous attempt to access the data word 100 was made, wherein the data word 100 did not store valid data. If no previous attempt to access the data word 100 was made at 215, wherein the data word 100 did not store valid data, at 220 an access is made to the data word in the another memory that is mapped to the data word 100. The foregoing determination can be made by examining the second bit 110.

If at 215, a previous access request had been made for data from another memory, possibly due to a previous attempt to request access from the data word 100, wherein the data word 100 did not store valid data, an access is not made to the data word in the another memory.

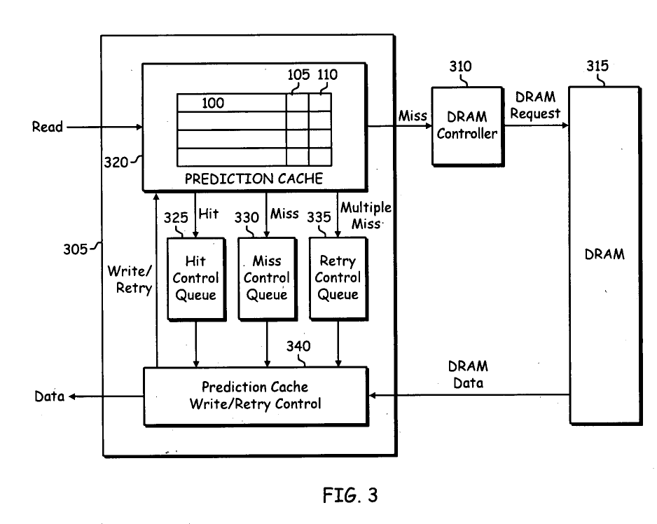

Referring now to FIG. 3, there is illustrated a block diagram describing an exemplary memory system in accordance with an embodiment of the present invention. The memory system comprises a Prediction Cache Module 305, a DRAM Controller 310, and a DRAM 315. The prediction cache module 305 comprises a Prediction Cache 320, Hit Control Queue 325, Miss Control Queue 330, Retry Control Queue 335, and Prediction Cache Write/Retry Control 340. The prediction cache 320 comprises data words, such as data words 100, a plurality of first bits 105, and a plurality of second bits 110.

The Prediction Cache Module 305 serves as a local cache for the fetched DRAM words in order to reduce the DRAM bandwidth requirement. Prediction cache 320 receives a data request from a client and classifies it as either a cache hit or a cache miss and decides whether the requested data is to be fetched from the DRAM 315 or not. If it decides the data is to be fetched from the DRAM 315, the prediction cache 320 sends the DRAM address to the DRAM Controller 310. For every request, the prediction cache 320 sends the request information to the Prediction Cache Write/Retry Control 340 which controls the data fetched from the DRAM 315 and returns the data, whether it is fetched from the DRAM 315 or from the prediction cache 320, to the client.

One data word 100 of cache memory is mapped to one DRAM word, and each has a bit 105 indicating whether there is a valid DRAM word in that cache memory, i.e. a tag bit is set to “1” when there is a valid DRAM word in the cache memory. If the data word 100 is valid, this is identified as a “hit”, otherwise it is identified as a “miss”.

The DRAM address is employed to address the cache memory. In a hierarchical addressing scheme, a cluster of cache memory addresses is grouped as a cache block, which holds a group of DRAM words and is addressed as a higher level entity than each cache memory address inside the cache block. The use of cache blocks enables efficient mapping of locations in the cache memory to DRAM addresses.

The “already missed” bit 110 indicates that an access request has previously been made, or a DRAM request is pending. Misses are sent to the DRAM controller only when a miss is not “already missed” or pending. Otherwise, when a read request is identified as a miss, a DRAM read request command containing the DRAM address is sent to the DRAM controller 310. In real-time operation of a practical system, there may be many DRAM clients requesting to read from or write to the DRAM 315. It may take some time before a DRAM read request from the Prediction Cache 320 is served and the DRAM 315 data is returned to the Prediction Cache Module 305. Additional read requests to the Prediction Cache Module 305 with the same address as one of the previously missed requests whose missed data has not yet been returned from the DRAM, i.e. multiple misses to the same address, can be prevented from resulting in redundant DRAM read operations.

Each cache memory data word 100 has associated with it a first tag bit 105 indicating whether or not it stores valid data from the DRAM address. When a read request to a specific address finds the associated tag bit has a value of “1”, it is identified as a hit. In the case of a hit, the DRAM word will be fetched from the cache memory and sent to a FIFO called the Hit Control Queue 325 along with other address and client information.

When a read request finds the tag bit 105 has a value of “0” it is identified as a miss. In addition to the tag bit, each cache memory entry is associated with a bit 110 that specifies whether a read request is a primary miss or a secondary miss, namely an already-missed bit. The already-missed bit 110 is initialized to “0” indicating that the associated cache entry has not previously been missed since this bit was reset. When a read request to the address results in a miss via the hit/miss bit 105 and it finds the already-missed bit of the cache memory equal to “0”, it is identified as a primary miss. The already-missed bit 110 is then set to “1”. In the exemplary embodiment, the already-missed bit is set to “1” only if the associated cache memory data word 100 is locked such it cannot be invalidated while misses are pending in the Prediction Cache Module 305.

The DRAM address of the primary miss will be sent to the DRAM controller 310. The client information and the DRAM address of the primary miss are used to form an entry that is sent to the Miss Control Queue 330. When a read request following the primary miss finds the already-missed bit 110 of the cache memory equal to “1”, it is identified as a secondary miss, and its DRAM address will not be sent to the DRAM controller 310. The client information and the DRAM address of the secondary miss are sent to another FIFO called the Retry Control Queue 335, and not to the Miss Control Queue 330. A counter is used to count the number of consecutive secondary misses intervening after each primary miss and before the next primary miss. This count value of intervening secondary misses is included in the entry associated with the second primary miss in the Miss Control Queue. This count value used to control the processing of entries in the Retry Control Queue 335.

The Prediction Cache Write/Retry Control 340 processes all the commands in the Hit Control Queue 325, the Miss Control Queue 330, and the Retry Control Queue 335. When a data word is fetched from the DRAM 315, the Prediction Cache Write/Retry Control 340 passes the data to the client. If the entry at the head of the Miss Control Queue 330 contains an intervening secondary miss count value of 0, this value is interpreted as meaning that the next data item to be processed is the next data that will be returned from DRAM, which will be associated with the next entry in the Miss Control Queue 330, and the entry at the head of the Retry Control Queue 335 is not yet ready to be processed. The Prediction Cache Write/Retry Control 340 pairs the data returned from DRAM with the entry at the head of the Miss Control Queue 330 to determine the address and client ID associated with the data, and it pops this command off the Miss Control Queue 330. If the entry at the head of the Miss Control Queue 330 contains an intervening secondary miss count value greater than 0, that means that a number, equal to the value of this intervening secondary miss count, of consecutive entries starting with the head of the Retry Control Queue 335 are yet ready to be processed. Those entries so identified at the head of the Retry Control Queue 335 are popped from the head of the queue and re-tried via the Prediction Cache 320, resulting in hits in the cache and data being returned to the associated clients. Since these intervening secondary misses refer to data which was previously received from DRAM and written to the Prediction Cache 320, all of them will result in Hits when they are re-tried.

In an alternative embodiment, there is no Retry Control Queue, and all misses go into the Miss Control Queue 300. Each entry in the Miss Control Queue has associated with it a bit indicating whether the entry represents a primary miss or a second miss. This works in a similar way and produces essentially the same results. With only the Miss Control Queue 330, the multiple misses are processed when they are at the head of the Miss Queue, while data may be concurrently returned from DRAM. In such an embodiment, the Prediction Cache Module 305 may store temporarily any data returned from DRAM while it processes the secondary misses at the head of the Miss Queue.

In another alternative embodiment, the re-tried secondary misses may not be guaranteed to result in hits when they are re-tried in the Prediction Cache 320. This may occur if the cache memory data word 100 associated with a re-tried secondary miss has been re-allocated to a different address. In such an embodiment, such secondary misses may again result in misses, which may be either primary or secondary misses.

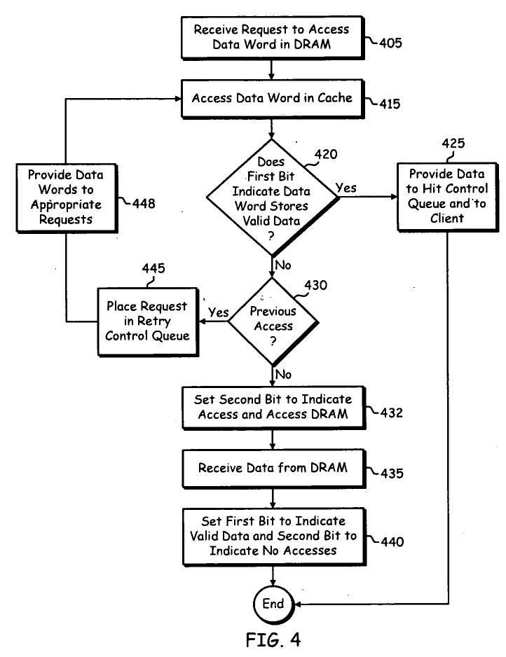

Referring now to FIG. 4, there is illustrated a flow diagram for accessing data in accordance with an embodiment of the present invention. At 405, a request to access a data word in DRAM 315 is received at the prediction cache 320. At 415, the data word 100 and associated bit 105 are accessed. At 420, a determination is made whether the data word 100 stores valid data by examining the first bit 105. If the data word 100 stores valid data at 420, the data stored at data word 100 is provided to the hit control queue 325 and the prediction cache write/retry control 340 provides the data to the client at 425.

If at 420, the data word 100 does not store valid data at 420 (as indicated by the first bit 105), at 430, the second bit 110 is examined and a determination is made whether a previous access request was made to the data word 100, wherein the data word 100 did not store valid data.

If 430 determines that no previous access request was made, the second bit is set at 432 to indicate this word was already missed and the DRAM controller 310 was already requested to access the data word mapped to data word 100. The prediction cache write/retry control 340 waits until the contents of the data word in the DRAM 315 are returned. When the contents are returned, at 435, the prediction cache write/retry control 340 provides the contents of the data word to the requesting client at 435, sets the first bit to indicate valid data, and sets the second bit to indicate no prior accesses, i.e. no prior miss, or no pending DRAM request at 440.

If at 430, a previous access request is determined, the request to access the data word is stored in the retry control queue 335 at 445. The request remains in the retry control queue 335 until the cache 305 receives the data from DRAM 315 from a previous request from the same address. The prediction cache write/retry control 340 receives the data word. At 448, the data words are associated with the appropriate requests that are in the retry control queue 335 and provided to the requesting client.

The foregoing can be used with a variety of applications. For example, in certain embodiments of the present invention, the foregoing can be used to facilitate video encoding and decoding in accordance with a compression/decompression standard such as MPEG-2 or AVC H.264/MPEG-4 Part 10.

Certain embodiments of the present invention comprise an efficient cache mechanism for video compression where a local RAM, namely Prediction Cache, is used to selectively store the pixel data loaded from the external DRAM. The Prediction Cache includes a locking mechanism that ensures that most data used by the motion search for one block of pixels will be kept in the Prediction Cache until the motion compensation of the same block of pixels has been completed. Locking may also be used to ensure that secondary misses result in hits when they are re-tried.

This improves the efficiency of the Prediction Cache in video encoding, where most reference pixel data required for the motion compensation form a subset of the reference data used by the motion search. The Prediction Cache also includes a mechanism to avoid multiple requests of the same data from the DRAM when the first request of the data has not been returned from the DRAM, i.e. secondary or multiple miss requests. This mechanism also improves Prediction Cache efficiency because there are many requests of the same data in video encoding and decoding where many overlapping pixels exist during motion search and motion compensation, i.e., the same word of data may be requested multiple times in close succession.

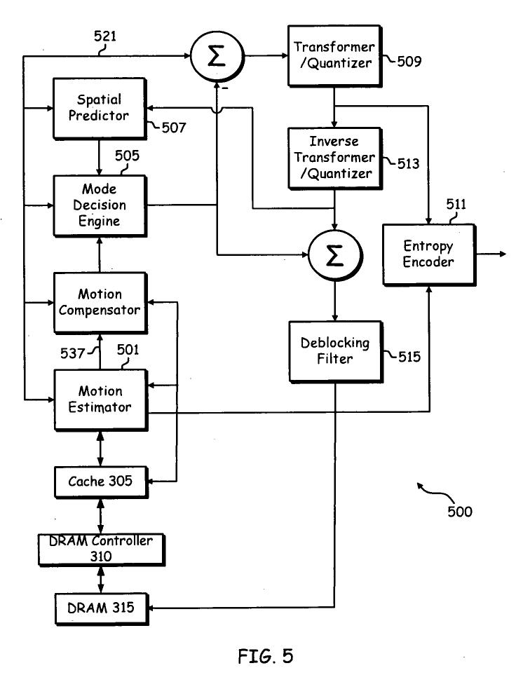

Referring now to FIG. 5, there is illustrated an exemplary video encoder 500 in accordance with an embodiment of the present invention. The video encoder 500 comprises a motion estimator 501, a motion compensator 503, a mode decision engine 505, spatial predictor 507, a transformer/quantizer 509, an entropy encoder 511, an inverse transformer/quantizer 513, and a deblocking filter 515.

In the motion estimator 501, a macroblock in a current picture 521 is predicted from reference pixels 535 using a set of motion vectors 537. The motion estimator 501 may receive the macroblock in the current picture 521 and a set of reference pixels 535 for prediction from DRAM 315. The motion estimator 501 may evaluate candidate motion vectors and select one or more of them. The motion estimator 501 may also evaluate various partitions of the macroblock and candidate motion vectors for the partitions. The motion estimator 501 may output motion vectors, associated quality metrics, and optional partitioning information.

The prediction cache module 305 and DRAM controller 310 can be used to facilitate access to the data stored in the DRAM 315 by the motion estimator 501 and motion compensator 503.

In an exemplary embodiment, the prediction cache 305 can service a variety of clients, such as a motion estimator client 501 or motion compensator 503 client. When the Prediction Cache 305 processes a read request from the motion estimator 501 client and the address associated with this read request has not been allocated in the Prediction Cache 320, it allocates and locks one cache memory entry (if a non-hierarchical addressing scheme is employed), or a cache memory block (if a hierarchical cache addressing scheme is employed). The lock function utilizes an index number associated with the number of the macroblock being processed; this is referred to as the lock index. Any locked cache memory entry or block can not be reallocated to store other data so that the cache memory entry or block is guaranteed to be available when the data is returned from the DRAM 315. The lock to the cache memory is released, i.e. the cache memory entry or block is unlocked, when the motion compensator 503 client has completed making all the requests to the Prediction Cache 320 that it will make for the reference pixel data of the macroblock with the same index as the lock index. The number of cache memory entries or blocks that can be locked may optionally be limited to a certain number per macroblock, for example to ensure that at least a certain number of entries or blocks is available for all macroblocks. When a cache memory entry or block associated with a DRAM address is not available to be locked, the Prediction Cache 320 processes the read requests to that entry or block without guaranteeing the cache memory entry or block will still be allocated to the address when the data is returned from the DRAM 315.

When data returned from DRAM is identified as having been requested by the motion estimator 501 client, it is written to the cache memory if the cache memory associated with the DRAM address is still allocated. At times when there is no data returning from the DRAM and the number of intervening secondary misses indicated by the entry at the head of the Miss Control Queue 330 is greater than zero, the Prediction Cache Write/Retry Control 340 processes up to the indicated number of secondary miss entries in the Retry Control Queue 335, whose data corresponding to primary misses that have been returned to the Prediction Cache 320, as retry commands to the cache. Because the locked cache memory will not be unlocked until the motion compensation client 630 completes processing the macroblock, it is guaranteed that the retry read commands result in hits. The number of entries at the head of the Retry Control Queue 335 that can be processed by the Prediction Cache Write/Retry Control 340 is the value of the counts of intervening secondary misses indicated in the entry at the head of the Miss Control Queue 340. When the Prediction Cache Write/Retry Control 340 processes entries in the Hit Control Queue 325, it simply passes the data to the indicated client.

In a video encoder, the Prediction Cache Module 305 serves multiple clients, such as Motion Estimation (ME) client 501, and Motion Compensation (MC) client 503. The state-of-the-art video compression standards specify encoding of video using macroblocks (MB) whose size is 16×16 pixels, as one unit. In an exemplary embodiment, to compress one macroblock, the motion estimator client 501 first requests the reference pixel data, associated with the candidate motion vectors, from the Prediction Cache Module 305, and decides a final set of motion vectors which the motion compensator client 503 will then use to fetch the blocks of reference pixels to predict the macroblock. The results of the prediction are used for further encoding. When a client sends a read request to the Prediction Cache 320, it identifies itself to the Prediction Cache 320 and it identifies which macroblock the pixel data is requested for.

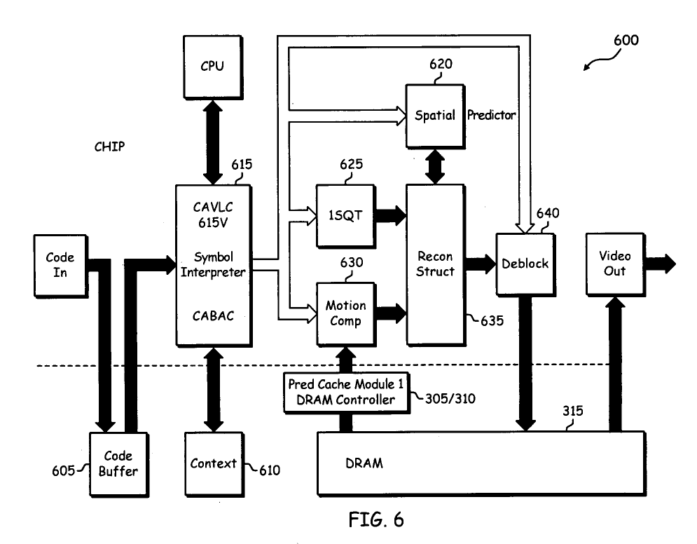

Referring now to FIG. 6, there is illustrated a block diagram of an exemplary AVC/H.264/MPEG-4, Part 10, video decoder in accordance with an embodiment of the present invention. The video decoder 600 includes a code buffer 605 for receiving a video elementary stream. The code buffer 605 can be a portion of a memory system, such as a dynamic random access memory (DRAM) 315. A symbol interpreter 615 in conjunction with a context memory 610 decodes the entropy coded (e.g. CABAC or CAVLC) symbols from the bit stream. The context memory 610 can be another portion of the same memory system as the code buffer 605, or a portion of another memory system. The symbol interpreter 615 includes a CAVLC decoder 615V and a CABAC decoder. The motion vector data and the quantized transformed coefficient data can either be CAVLC or CABAC coded. Accordingly, either the CAVLC decoder or CABAC decoder decodes the CAVLC or CABAC coding of the motion vectors data and transformed coefficient data.

The symbol interpreter 615 provides the sets of scanned quantized frequency coefficients to an inverse scanner, inverse quantizer, and inverse transformer (ISQT) 625. Depending on the prediction mode for the macroblock associated with the scanned quantized frequency coefficients, the symbol interpreter 615 provides motion vectors to the motion compensator 630, where motion compensation is applied. Where spatial prediction is used, the symbol interpreter 615 provides intra-mode information to the spatial predictor 620.

The ISQT 625 (inverse scan, quantize and transform) constructs the prediction error. The spatial predictor 620 generates the prediction pixels for spatially predicted macroblocks while the motion compensator 630 generates the prediction pixels for temporally predicted macroblocks. The motion compensator 630 retrieves the necessary reference pixels for generating the prediction pixels from DRAM 315, which stores previously decoded frames or fields from DRAM 315.

A pixel reconstructor 635 receives the prediction error from the ISQT 625, and the prediction pixels P from either the motion compensator 630 or spatial predictor 620. The pixel reconstructor 635 reconstructs the macroblock from the foregoing information and provides the macroblock to a deblocker 640. The deblocker 640 smoothes pixels at the edges of the macroblock to reduce the appearance of blocking. The deblocker 640 writes the decoded macroblock to the DRAM 315.

The prediction cache module 305 and DRAM controller 310 can be used to facilitate efficient access by the motion compensator to the data stored in the DRAM 315.

The embodiments described herein may be implemented as a board level product, as a single chip, application specific integrated circuit (ASIC), or with varying levels of the system integrated with other portions of the system as separate components. The degree of integration of the system is typically determined by speed and cost considerations. Because of the sophisticated nature of modern processors, it is possible to utilize a commercially available processor, which may be implemented external to an ASIC implementation. If the processor is available as an ASIC core or logic block, then the commercially available processor can be implemented as part of an ASIC device wherein certain functions can be implemented in firmware. Alternatively, the functions can be implemented as hardware accelerator units controlled by the processor.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A cache system for storing data, said cache comprising:
a plurality of memory data words in a first memory for storing data;
a first plurality of bits, wherein each of the first plurality of bits corresponds to a particular one of the plurality of memory data words, each of the plurality of bits for indicating whether the memory data word corresponding thereto stores valid data; and
a second plurality of bits, wherein each of the second plurality of bits corresponds to a particular one of the plurality of memory data words, each of the plurality of bits for indicating whether a cache miss has previously occurred with the memory data word corresponding thereto.

2. The cache system of claim 1, wherein each of the plurality of memory data words in the first memory correspond to one of a plurality of data words in another memory, and wherein the cache system receives a request to access a particular data word in the another memory.

3. The cache system of claim 2, further comprising:
a memory controller for accessing the particular data word in the another memory if:
the particular data word in the another memory is not stored in one of the plurality of memory data words in the first memory; or
the first bit corresponding to the one of the plurality of memory data words in the first memory corresponding to the particular data word in the another memory indicates that the one of the plurality of memory data words in the first memory does not contain valid data and the second bit corresponding to the one of the plurality of memory data words in the first memory corresponding to the particular data word in the another memory does not indicate that a cache miss has occurred.

4. The cache system of claim 2, further comprising:
a first queue for storing the request to access the particular data word in the another memory if the first bit corresponding to the one of the plurality of memory data words in the first memory corresponding to the particular data word in the another memory indicates that the one of the plurality of memory data words in the first memory does not contain valid data and the second bit corresponding to the one of the plurality of memory data words in the first memory corresponding to the particular data word in the another memory does not indicate that a previous cache miss has occurred; and
a second queue for storing the request to access the particular data word in the another memory if the first bit corresponding to the one of the plurality of memory data words in the first memory corresponding to the particular data word in the another memory indicates that the one of the plurality of memory data words in the first memory does not contain valid data and the second bit corresponding to the one of the plurality of memory data words in the first memory corresponding to the particular data word in the another memory does indicate that a previous cache miss has occurred.

5. The cache system of claim 2, further comprising:
a queue for storing the request to access the particular data word in the another memory if the first bit corresponding to the one of the plurality of memory data words in the first memory corresponding to the particular data word in the another memory indicates that the one of the plurality of memory data words in the first memory does not contain valid data and, associated with each request, a bit indicating whether the second bit corresponding to the one of the plurality of memory data words in the first memory corresponding to the particular data word in the another memory indicates that a previous cache miss has occurred.

6. The cache system of claim 2, further comprising:
a controller for receiving contents of the particular data words in the another memory from the another memory and writing the contents in the particular ones of the plurality of memory data words in the first memory corresponding to the particular data words in the another memory.

7. The cache system of claim 6, wherein the first bits associated with the particular ones of the plurality of data words corresponding the particular data words in the another memory indicate storage of valid data when the controller writes the contents.

8. The cache system of claim 6, wherein the controller retries the requests to access the particular word in the another memory from the second queue.

9. A method for providing data, said method comprising:
receiving a request to access a particular word in a memory at a cache;
if the particular word is mapped to a particular word in the cache:
providing the contents of the particular word in the cache if the particular word stores valid data; and
requesting the contents of the particular word in the memory if the particular word in the cache does not store valid data, and if the particular word has not had a previous cache miss.

10. The method of claim 9, wherein whether the particular word in the cache stores valid data is determined by examining a first indicator associated with the particular word in the cache.

11. The method of claim 9, wherein whether the particular word in the cache has had a previous cache miss is determined by examining a second indicator associated with the particular word in the cache.

12. The method of claim 11, further comprising:
setting the second indicator associated with the particular word in the cache to indicate a previous cache miss if the particular word in the cache does not store valid data, and if the particular word has not had a previous cache miss.

13. The method of claim 12, further comprising:
receiving the contents of the particular word in the another memory;
writing the contents of the particular word in the another memory to the particular word in the cache after receiving the contents; and
setting the first indicator associated with the particular word in the cache to indicate that the particular word in the cache stores valid data.

14. The method of claim 13, further comprising:
retrying the request to access the particular word in a memory at a cache if the particular word in the cache does not store valid data, and if the particular word has not had a previous cache miss.
